(19) United States
(12) Patent Application Publication
(10) Pub. No.: US 2009/0172136 A1
(43) Pub. Date: Jul. 2, 2009

(54) METHOD AND SYSTEM FOR THE DISTRIBUTION OF CONFIGURATIONS TO CLIENT COMPUTERS

(76) Inventors: Ulrich Schulz, Bornheim (DE); Dirk Suchodoletz, Freiburg (DE)

Correspondence Address: KENYON & KENYON LLP, ONE BROADWAY, NEW YORK, NY, 10004, US

(21) Appl. No.: 11/994,326

(22) PCT Filed: Jun. 7, 2006
(86) PCT No.: PCT/DE2006/000978

§ 371 Date: Nov. 24, 2008

(30) Foreign Application Priority Data
Jun. 30, 2005 (DE) 102005030529.6

(51) Int. Cl. G06F 15/177; H04L 9/32

(52) U.S. Cl. 709/222; 713/2; 726/5; 718/1

(57) ABSTRACT

A method for distributing computer configurations to at least one client from a server, comprising the following steps: Network-booting a first operating system for the clients from a server, automatically loading a virtual machine having an elective second operating system on the basis of the booted (first) operating system while taking into consideration one or more of the following parameters: user login, network address. Consequently, providing a full fat client (standard PC) functionality under an elective operating system on a (diskless) client hardware by using exclusively volatile storage media (on the new thin client system).

### FIELD OF THE INVENTION

The present invention relates generally to methods and systems for distributing configurations to client computers.

### BACKGROUND INFORMATION

In the thin client sector, thin clients are used as viewers, i.e., visualizing the output of application software, which take on the, e.g., possibly graphical, representation. The actual computing work, i.e., the execution of application software, is performed on the application server. Some classical exponents of this mode of operation include the Citrix system by Citrix, the SUN Ray project by the SUN company, terminal server variants by the Microsoft company, the X terminal system in the Unix area, and the Linux terminal server project (“LTSP”) system in the open source area. For this purpose, the thin client systems are equipped either with hard disks or boot EPROMs (i.e., erasable programmable read-only memory or other non-volatile storage media), which contain the operating software in order to ensure, after switching on the client computer, the visualization of the actual computing operations on the server.

It is characteristic of these thin client systems that the application software is installed on one or multiple central servers and is executed there as well. The thin client computers only take on the subordinated function of visualization. Another characteristic feature is the fact that the current systems mentioned above all are tied to the use of one operating system.

Classrooms or computer pool rooms for teaching classes are standard facilities at, e.g., a university computing center or other computing centers. Normally, employees of a computing center teach a series of standard courses. In addition, members of the various faculties may book these rooms for their own activities. The spectrum of these courses ranges from introductions to HTML and internet publishing to the use of office packages and even to Linux administration and network courses. Accordingly, the requirements placed on the installed operating system, the necessary software and the privileges of the users in accessing the resources may differ substantially.

The current solutions in the computing center operate with, e.g., Windows NT machines and a separate user administration. Limited by the capacity of the hard disks used and problems with the Windows registration database, it was not possible to achieve a “complete” installation of all desired software packages in one environment. In addition, the machines are administered manually such that all installations are seldom identical. Thus, it is not unusual for various packages not to work on different machines or not to be installed completely. Since it was not possible to conduct complex tests prior to every course, the course instructor bore the risk.

To achieve at least a certain flexibility, swappable hard disks have been used. This means, however, that the drives possibly had to be exchanged prior to class. Such an exchange can involve considerable time, and various disk installations have to be maintained. In addition, there have been problems with the swap racks. For these example reasons, the rooms could not be made available outside of courses to the general public as practical work and practice spaces.

### SUMMARY OF THE INVENTION

In embodiments of the present invention, a system and method involving the usual client functionalities (standard PC) under an elective operating systems in a high-performance mode on diskless client hardware is provided.

In embodiments of the present invention, systems and method are provided which make course operations in computing centers more flexible. For example, the computing center does not prescribe a fixed course environment, as is customary, but rather grants course instructors a large say in the selection and configuration of the software used.

In an embodiment of the present invention, Linux or other basic operating system having an extensive driver support and starting from a central boot server (e.g., as a diskless client) is provided, and drastically simplifies the administration of all computer pool machines.

In an embodiment of the present invention, the operating system is not installed locally on any course computer. This significantly may reduce the update work and prevent manipulations.

In an embodiment of the present invention, all course contents that cannot be covered by the Linux standard installation, such as Windows XP-based courses (or quasi any other PC operating system), may be run on a virtual machine, e.g., VMware.

In an embodiment of the present invention, the virtual machine allows for installation of the course system centrally and distribution.

In an embodiment of the present invention, course instructors are able to prepare their contents (software, operating system, settings) at home on their own PC or laptop or in any other place where a virtual machine is installed.

In an embodiment of the present invention, a course installed on the central server is automatically available on all computer pool machines, it being possible to make the assignment of the course automatic, based on a login or in combination with a selection dialog. In the automatic assignment, this occurs, for example, on the basis of fixed network addresses (e.g., MAC) such that a spatial restriction is possible. In an embodiment, the login makes it possible to assign virtual machines in a variable manner and even individually. The combination with a selection menu is possible as well, a selection of virtual machines being provided as a function of the positive identification or the login, among which virtual machines the user may select.

Accordingly, in an embodiment of the present invention, exactly the same interface and equipment of a course is available on all computers.

In an embodiment of the present invention, changes to the installation are only local with respect to the machine and inoperative following a restart. Manipulations are thus excluded, and viruses and worms (problems of popular operating systems) are unable to find a permanent host. The operation is more robust and is unproblematic even when unsupervised.

In an embodiment of the present invention, the course rooms may now offer a significantly wider range of operating options, e.g., Linux a the base system and various other operating systems in VMware.

In an embodiment of the present invention, in free practice time, each user may use exactly his course environment regardless of who else is working in the room.

In an embodiment of the present invention, the switching times between different courses are minimal and merely involve the time from logging out one user and logging on the next.

In an embodiment of the present invention, within the virtual machine, users may be granted higher rights (up to system administrator) at lower risk because changes persist only until restart.

In an embodiment of the present invention, the new pool concept now makes it possible for external providers to teach courses using software that is not or cannot be provided by the computing center itself. This is imported for the duration of a course and is subsequently removed again from the server. The long term management of different course contents is also substantially simplified. Prepared images may be stored over longer periods without undergoing changes in the process.

In an embodiment of the present invention, the system includes one or multiple central server computers and—on the client side—of one or multiple new thin client (NTC) computers.

In an embodiment of the present invention, in the new thin client system described here, the distribution of tasks is managed differently. Here the actual computing work or execution of application software takes place on the client side, e.g., on the NTC computers. These have no operating system software contained on hard disks or on EPROMs or on other non-volatile storage media. A central server provides the new thin client computer with the services to load the base operating software, e.g., the base operating system of the NTC computer, e.g., Linux/Unix, over the network and thus to boot. If this base operating system is installed on the NTC computer following the loading process, then it is located completely in the RAM (that is, in the volatile memory) of the NTC computer and is lost after the new thin client computer is switched off. A pure software approach does not presuppose any special measures on the new thin client computers—except, of course, the capability of booting over the network.

Embodiments of the present invention may yield a series of advantages, including that the new thin client computers are subject to only the most minimal hardware requirements.

In embodiments of the present invention, except for the boot phase of the NTC computers, the computing load on the central server(s) is very low in comparison to existing thin client systems.

In embodiments of the present invention, the base operating system, e.g., Linux/Unix, of each new thin client computer is located in one exemplar centrally on a server and is identical for all new thin client computers. Modifications/maintenance are thus to be performed exclusively in one place on the central server and are then immediately available for all NTC computers.

An embodiment of the present invention design approach can reproduce the capabilities of the existing thin client systems (RDP, Citrix, X11 etc.) quasi by the way. This occurs at no or only a slightly higher expenditure and without incurring the usual administration problems.

In an embodiment of the present invention, after booting the NTC computer, the user has the choice with which secondary operating system or with which variant of a secondary operating system he would like to work. The base operating system contains a hardware simulator (e.g., VMware), which virtually provided the respectively required hardware to the secondary operating system which the user has selected for his work. This selected (secondary) operating system is then booted on top of the base operating system (e.g., Linux/Unix). For this purpose, the new thin client computer, and thus the secondary operating system, are in each case provided, again virtually, with the required hard disk image of the underlying base operating system.

In embodiments of the present invention, additional advantages of this NTC system include the following.

The respective user of a new thin client computer is not tied down in the choice of operating system with which he wants to work.

Multiple images of various secondary operating systems and/or different variants of secondary operating systems may be provided.

The diverse secondary operating system images also exist only in one exemplar on one central server. Here too, modifications/maintenance are to be performed exclusively in one central place and are then immediately available for all new thin client computers.

In order to ensure a flexible course operation, the course teachers may prepare their desired Windows course environment on any machines that have VMware installed. For this purpose, there exists a selection of preassembled installations, from which they may select something suitable and make modifications as needed. To facilitate management of the various VM installations, all course instructors are provided with a specially developed program under Windows. This allows them to set up, make available and remove images in the course room. This tool gives even less experienced course instructors the possibility to prepare and adapt their courses. Additional software tools for redirecting, for example, individual course stations to the projector are also conceivable.

The usability and robustness of the installation increased such that the rooms may be unproblematically opened for free practice even outside of the course times. The concept of Windows images allows for very flexible operations, and courses may now be held in close succession, while preparations may be long-term. However, there still remain points to be resolved:

Generally, this design approach made up of Linux diskless clients together with VMware allows for a reduction of expenditure in personnel: After the investment in the server installation and the adaptation of the client environment, only the usual maintenance work on the installed hardware and on one of the servers are incurred. The idle times of the room in conversion phases, the personnel-intensive swapping of hard disks and the laborious installation of a multitude of machines are eliminated.

Existing thin client design approaches visualize the output of application software that is executed on a central server, that is, not on the thin client computers. Additionally, thin client approaches require on the client side non-volatile memories (hard disks, PROMs, EPROMs etc.), which contain defined operating system or application software in the switched-off state of the thin client.

By contrast, the application software in an NTC system runs exclusively on the NTC computers, the central server merely passing the application software to the NTC computer. On the client side (the NTC computer), the operating system or the application software is in no form present on a non-volatile memory (hard disk, EPROM etc.), both being passed by a central server to the NTC computer after the latter is started. Because of the exclusive use of volatile memories on the client side, both for the operating system software as well as for the application software, after the NTC computer has started there is a choice in particular as regards the (secondary) operating system (e.g., LINUX, UNIX, Windows 9x/2000/XP, etc.) running on the NTC computer.

Embodiments of the present invention develop the concept of centrally controlled computer pools further. In so doing it automates the necessary operating steps of the setup to such an extent that, e.g., from a standard SuSE Linux installation a server may be set up for a large pool of machines by only a few manipulations.

Thin clients should be easy to operate, but at the same time support a certain selection of hardware since a homogeneous hardware configuration is seldom provided. The boot software to be used should not require expensive special hardware, but should preferably take advantage of the given facts of the PC hardware already in use. After switching off the machine, the boot software must be available again and must be capable of being activated automatically in standard operation without special user interaction.

Intel's PXE—the PXE option is present in the BIOS of almost all motherboards that have an onboard network card—represents another option for starting a machine that has no hard disk over the network. Via DHCP/TFTP, a PXE image is loaded, which then provides further boot functionality. Besides other boot functions, the Syslinux package also contains support for PXE. This is then able to boot and start special Linux kernels via TFTP.

In an embodiment of the present invention, the setup of a file system, e.g., the root file system of a thin client that does not have its own permanent storage, necessarily deviates from the customary hard disk installation. In this regard, there is a series of design aspects to be observed.

In an embodiment of the present invention, the structure of the file system of the free Unix derivatives is subject to the file system hierarchy standard, which classifies the files as local or distributable and static or dynamic.

In an embodiment of the present invention, the declared aim of setting up a file system of the thin clients is to make it possible to serve a great number of machines regardless of their later function or their equipment from a unified directory. It saves permanent storage space, which in light of today's hard disk sizes is no longer the scarcity factor, but which in very many machines turns into an administration problem. Additionally, a unified directory for all clients has a positive effect on the caching behavior of the server. Frequently requested data blocks may thus be served quickly from the working memory.

At the same time, in an embodiment of the present invention, as large a part of the file system as possible should be available on the clients in read-only form via NFS. This avoids interferences between different clients and contributes substantially toward increasing the security in a network of diskless clients. There are areas, however, such as directories for configuration files and the /var directory, which make it possible, at least in large areas, to allow programs on the client to perform write operations. Only in this manner in this embodiment, is it possible to achieve a dynamic configuration. In an embodiment, one will want to store these areas primarily in the RAM of the client so as not to have to set up or open sensitive configuration directories on the server specifically for each client.

In an embodiment of the present invention, the Linux diskless client presented here is initialized analogously to the kernel start of recent Linux distributions. Prior to the actual mounting of the root file system, a minimal ramdisk environment is executed, which takes on a series of configuration tasks such as, for example, loading special kernel modules for file systems or RAID hard disks. Some advantages of a bipartition of the boot procedure lie in the simplification of the kernel and the debugging. Those core elements are firmly integrated into the kernel that are required for starting, while all others may be loaded subsequently as needed.

In an embodiment of the present invention, for installation, the thin clients require extra setup work compared to the classical workstation, which pays off, however, already in the case of a small number of identical computer workplaces. In its implementation, the design approach presented here had its sights on future scaling. Once the base is created, it is possible, with only little additional effort, which is far below that for individual classical workstations, to administer a much higher number. It thus represents a resilient concept for managing an ever greater number of computers using less personnel. Other fields of application result as a platform for the remote installation of smaller islands via remote servers.

The new thin client system is made up of the combination of at least one server computer and at least one, normally, however, several or many, new thin clients (NTC).

In addition to its function as file server, the server computer also provides all additional required network services.

The new thin client computer has only minimal equipment, which in addition to the standard cluster interfaces at any rate includes a TFTP-bootable network environment.

In an embodiment of the present invention, the following requirements may be placed on the server.

In an embodiment, a sufficiently capable network connection in order be able to process the requests of all NTCs in a reasonable response time.

In an embodiment, a sufficiently large hard disk storage capacity such that in addition to the home directories of the individual users there is also space for temporary files of the respective client computers. In addition, the boot images of the NTC computers must also be stored on the server computer.

In an embodiment, if the handling capacity of an individual server does not suffice, additional servers may be added to the system so as to distribute the required network services to multiple servers and thus to ensure a sufficient handling capacity.

In an embodiment, each individual NTC computer, on the other hand, is only minimally equipped. This includes local standard interfaces such as keyboard, mouse, monitor and possibly printer port, CPU and RAM, LAN connection via wired LAN or wireless LAN and an FTP-bootable network environment such as e.g. PXE or etherboot.

In an embodiment, the software system is nested between server and client. The basis both for the server as well as the client is the (base) operating system, e.g., Linux/Unix/other operating systems). The client, however, accommodates a hardware simulator (e.g., VMware) in the base system to be loaded via TFTP, which makes it possible to execute on the NTC computer any desired target (or secondary) operating system on top of the existing base operating system. This may be either a Linux/Unix system or, e.g., also any variant of a Windows system such as, e.g., Windows 98 or Windows XP.

In an embodiment of the present invention, the NTC receives its base operating system only via TFTP as an image (diskless client) when the system is booting. This represents the base on which the emulator provides the user, at the time of logon, with the desired target operating system again as an image.

In an embodiment of the present invention, these target (or secondary) operating systems are stored in the most diverse variants and developments in a single instance as an image on a central server computer. The individual NTC computers thus always receive the identical image. In an embodiment, possible modifications are performed locally by the user on his NTC computer at runtime. Unless the user stores these changes in his home directory on the central file server, all local modifications are lost when the NTC computer is switched off since the NTC computer, following reboot, again operates using the unmodified original image (from the central server).

In an embodiment, the administration of the software versions with which the users work thus occurs only in one single place, namely, in the respective operating system image that the respective users select when booting. Changes made in that location are thus immediately available to all other users as well who select the same image of their operating system variant when logging on.

In an embodiment, the server provides the system with the following example network services:
DHCP and TFTP when booting the system
NFS/network block device as swap space for the clients
LDAP for administering e.g. the user accounts
NFS/network block device and SAMBA as file server (NFS/network block device in Linux/Unix, Samba in WinXX)

In an embodiment, in addition to the network services, the server must also store the (base) operating system images, by which the clients execute their boot operation.

In an embodiment, the only software the client must bring along is the option of making use via boot PROM of the DHCP and TFTP system for booting. This is achieved, e.g., using a standard PXE boot PROM.

Various possibilities exist for preparing the image.

An example embodiment includes equipping a single client computer, which functions as a reference computer, with a hard disk. On this hard disk, the target system (secondary system) for the NTC is installed and equipped with the intended software (e.g., in addition to VMware and Windows XP also with the Star Office suite or the Windows Office suite or another required software). One is thus able to test the desired system completely with respect to its operability. Then a hard disk image is created, e.g. with the aid of the Linux/Unix command rsync, on the server computer, which then is made available for all diskless NTC computers to read.

Some Linux variants (e.g., SuSE Linux) also allow for a complete system to be installed in one directory and for extensions and modifications to be performed there as well. IN an embodiment, no separate reference computer is required since direct access to the image is provided.

After the NTC computer is switched on it sends a DHCP broadcast in order to obtain from the DHCP server the IP address valid for it. With this address it turns to the TFTP server and from there obtains its base boot image (e.g. LINUX/Unix).

After this image is booted, a standard (Linux/Unix) login prompt is available. Here the user may identify himself either by the classical method by username and password or another method such as e.g. with the aid of smart cards or a fingerprint identifier.

When logging on, the user either indicates with which secondary or target operating system variant he would like to work or this information is already contained in the LDAP database and may be retrieved there. The underlying Linux/Unix system then starts the emulator (e.g., VMware), which in turn accesses the desired secondary operating system image, which itself is then made available to the emulator via NFS.

If the user is then logged on, the server computer makes its services available as file server in order to store—transparently for the user—the user's files in his user directory. The logging-out process then proceeds following the classical method or, e.g., with the use of smart cards by the fact that the user removes the smart card from the card reader. Depending on the operating system variant used, the user's current session is stored in his user directory and will be again available to the user when he logs on again, possibly on another client computer.

### BRIEF DESCRIPTION OF THE DRAWING

FIG. 1 shows a hard-diskless boot process of a Linux system.

### DETAILED DESCRIPTION

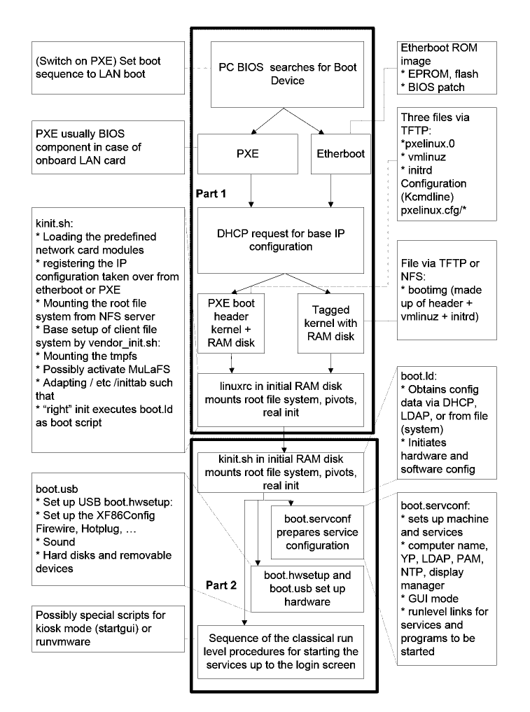

FIG. 1 shows a hard-diskless boot process of a Linux system, the latter booting either via PXE or via a PROM on the ethernet card (etherboot). In the next step, a DHCP request for providing the IP address is sent, it also being possible for the IP address to be assigned on the basis of the MAC. Thereupon a RAM disk having a base kernel is booted so as then to mount the additional file systems. In the second step the run level of the system is determined, and the services are started in accordance with the computer name until a login is available. On the basis of the login, the configured boot image is then started using the VMware, e.g., via an LDAP configuration. The latter may also be started immediately, without login. It is also possible to provide, as a function of user groups, a series of images, which the user may select. Thus a multitude of variants is possible.

1-9. (canceled)

10. A method for distributing computer configurations to at least one client from a server, comprising:
network booting of the client from the server of a first operating system;
automatic loading of a virtual machine having a second operating system from the server on the basis of the first operating system while taking into account at least one parameter of: a user login and a network address.

11. The method of claim 10, wherein the server has a storage area in which images for the second operating systems are stored, access to the images depending on the at least one parameter of: a user login and a network address.

12. The method of claim 10, further comprising after loading the first operating system opening automatically a menu allowing a selection of the second operating system.

13. The method of claim 10, wherein the selection points in the menu are restricted by the at least one parameter of: a user login and a network address.

14. The method of claim 12, wherein the selection of the second operating system occurs via an entry in a directory service.

15. The method of claim 10, further comprising storing a state of the second operating system on a network disk drive assigned to a user such that the latter may optionally access one or more second operating systems in another state.

16. The method of claim 15, wherein the stored second operating systems are provided as alternatives in a menu dialog as soon as available.

17. A server system for providing computer configurations on at least one client, the client booting from the network, comprising:
a device to allow for booting a client from a first server having a first operating system, the first operating system being set up in such a way that after loading the first operating system a virtual machine having a second operating system is loaded automatically from the server on the basis of the first operating system while taking into consideration at least one parameter of a user login and a network address.

18. The server system of claim 17, further comprising a database for administering images for the second operating system, via which access to the images is controlled on the basis of one of a computer address and a user login.

19. The method of claim 14, wherein the directory service is lightweight directory access protocol directory service.

20. A server system for providing computer configurations on at least one client, the client booting from the network, comprising:
a device to allow for booting a client by a first server having a first operating system,
wherein the first operating system is configured so that after loading the first operating system, a virtual machine having a second operating system is loaded automatically from the first server on the basis of the first operating system while taking into consideration a predefined parameter.

21. The server system of claim 20, wherein the predefined parameter is at least one of a user login and a network address.
